(19) United States
(12) Patent Application Publication
(10) Pub. No.: US 2026/0307106 A1
(43) Pub. Date: Oct. 8, 2026

(54) ULTRASONIC TRANSDUCER, METHOD FOR OPERATING AN ULTRASONIC TRANSDUCER, AND METHOD FOR MEASURING DISTANCE

(71) Applicant: TDK Electronics AG, München (DE)

(72) Inventors: Johannes Kofler, Graz (AT); Amira Hedhili, Graz (AT)

(21) Appl. No.: 19/481,513

(22) PCT Filed: Apr. 15, 2024
(86) PCT No.: PCT/EP2024/060168

§ 371 Date: Nov. 4, 2025

(30) Foreign Application Priority Data
May 8, 2023 (DE) 102023111922.2

(51) Int. Cl. B06B 1/06; B06B 1/02; G01S 7/524; G01S 15/10

(52) U.S. Cl. CPC B06B 1/0651; B06B 1/0215; G01S 7/524; G01S 15/10; B06B 2201/30; B06B 2201/55

(57) ABSTRACT

In an embodiment an ultrasonic transducer includes a membrane disposed in a housing, an actuator and a damper, wherein the actuator is configured to excite the membrane to oscillate in a sending mode for emitting an ultrasonic wave, wherein the damper is configured to dampen a post-excitation ringing of the membrane and to excite at least one damping mode that is different from the sending mode, and wherein at least one side wall of the housing has at least one thickness such that the sending mode and the damping mode are stably excited.

### CROSS-REFERENCE TO RELATED APPLICATIONS

This patent application is a national phase filing under section 371 of PCT/EP2024/060168, filed Apr. 15, 2024, which claims the priority of German patent application no. 102023111922.2, filed May 8, 2023, each of which is incorporated herein by reference in its entirety.

### TECHNICAL FIELD

The invention relates to an ultrasonic transducer, a method for operating an ultrasonic transducer, and a method for measuring distance.

### BACKGROUND

Piezoelectric ultrasonic transducers are used both to transmit and receive ultrasonic signals and are used, for example, as distance sensors in motor vehicles. However, such ultrasonic transducers conventionally continue to emit ultrasound even after all excitation of the transmission of ultrasonic signals has ceased. The reason for this is, in particular, the ringing of a membrane of the ultrasonic transducer, by means of which the ultrasonic signals are generated. This ringing makes it difficult to detect an ultrasonic signal with the same membrane.

From the publications U.S. Pat. Nos. 4,580,251, 6,731,569 B2, GB 2593477 A, and Liu et al. “Reducing ring-down time of pMUTs with phase shift of driving waveform.” Sensors and Actuators A 281 (2018) 100-107, and Wu et al. “A Novel Transfer Function Based Ring-Down Suppression System for PMUTs.” Sensors 2021, 21, 6414, ultrasonic transducers and methods for operating ultrasonic transducers are known.

### SUMMARY

Embodiments provide an improved ultrasonic transducer and an improved method for operating an ultrasonic transducer.

Embodiments provide an ultrasonic transducer which comprises a membrane in a housing, an actuating means and a damping means. The actuating means is configured to excite the membrane to oscillate in a sending mode for emitting an ultrasonic wave. The damping means is configured to dampen a post-excitation ringing of the membrane. The damping means is further configured to excite at least one damping mode that is different from the sending mode. At least one side wall of the housing has a thickness such that the sending mode and the damping mode can be excited stably.

For example, the sending mode has a sending frequency. The damping mode has, for example, a damping frequency. The sending frequency and the damping frequency preferably differ. The damping mode and the sending mode can be normal modes of the membrane or of the ultrasonic transducer, respectively. The membrane comprises, for example, aluminum or is formed therefrom.

The sending mode and the damping mode may differ in the sending frequency and the damping frequency. In particular, the damping frequency is higher than the sending frequency. In addition, the sending mode and the damping mode may differ, for example, in the arrangement of extreme points and oscillation nodes.

The actuating means is specifically configured to excite the membrane to emit an ultrasonic wave that can be used for distance measurement. Thereby, the actuating means excites the sending mode. This causes the membrane to oscillate and generates the ultrasonic wave. The membrane preferably oscillates in resonance, which allows the ultrasonic wave to be generated particularly efficiently. Furthermore, the sending mode preferably has a relatively low or as low as possible dissipation in order to achieve effective emission of the ultrasonic wave.

During operation of the ultrasonic transducer, the transmitted ultrasonic wave is reflected by an object whose distance is to be determined. The reflected ultrasonic wave is then preferably registered by causing the membrane to oscillate. This means that the reflected wave excites the membrane to oscillate. Since the reflected wave results from the ultrasonic wave generated by the sending mode and transmitted, the reflected wave excites in particular the sending mode or a mode similar to the sending mode. Since the intensity of the excitation by the reflected wave is lower than the excitation by the actuating means, the sending mode preferably has a comparatively low dissipation or damping so that it can be stably excited by the reflected wave. Furthermore, the ringing of the membrane after the transmission of the ultrasonic wave has preferably decayed or essentially decayed so that a change in the membrane oscillation due to the reflected wave is detectable. In other words, the membrane or the ultrasonic transducer is sensitive to the reflected wave after the damping.

The damping means is particularly configured to dampen the ringing of membrane by exciting the damping mode or damping modes. The ringing occurs in particular because, during operation, the membrane was excited by the actuating means to a resonant oscillation that has comparatively low dissipation. Therefore, the membrane oscillation decays only relatively slowly and improved damping, for example active damping, is required.

The damping mode or damping modes excited for damping are, in particular, a stable mode that exhibits relatively high dissipation. This means that when the membrane oscillates with the damping mode or damping modes, energy is dissipated and the oscillation decays. In particular, the damping mode or damping modes exhibit higher damping or dissipation than the sending mode. This allows active and effective damping of the ringing to be achieved by specifically exciting at least one damping mode.

If a feature related to the damping mode is disclosed below, it is also disclosed accordingly for multiple damping modes, unless otherwise specified.

The housing is preferably designed so that the sending mode and the damping mode can be excited stably. In particular, a side wall of the housing has at least one thickness so that the sending mode and the damping mode can be excited stably. The housing may, for example, have several thicknesses, for example in several regions. It is also possible that the side wall has only one thickness. “Has at least one thickness” means in particular that one of these thicknesses or all of these thicknesses are adjusted or selected so that the sending mode and the damping mode can be stably excited. This means that the housing has, for example, a wall thickness in certain regions or at certain points that enables stable excitation of the sending mode and damping mode.

Here and in the following, a “stable mode” is understood to be a mode that is stable over a certain period of time. For example, the damping mode is stable in order to achieve continuous damping and thus effective decay of the ringing. The sending mode is preferably stable in order to achieve effective transmission of the ultrasonic wave.

In particular, the housing has one or more side walls that extend transversely or perpendicularly to a main extension plane of the membrane.

The housing is preferably rotationally symmetrical. For example, the housing has a central axis of symmetry. The axis of symmetry can be a central axis of the housing. The housing is preferably a pot housing.

The membrane is arranged, for example, in a bottom region of the housing. This means, in particular, that the side wall extends from the membrane in a direction transverse or perpendicular to the membrane.

The housing comprises, for example, a metal and is formed in one piece. The membrane preferably also comprises a metal. The housing and/or the membrane comprise, for example, aluminum.

The side wall preferably has at least a first region and at least a second region. In the first region, the side wall has, for example, a thickness that is greater than the thickness of the side wall in the second region. The first region of the side wall preferably borders directly on the membrane.

It is also possible for the side wall to have more than two regions. Preferably, the side wall has a different thickness in each of the regions.

Alternatively or additionally, it is possible for the side wall to have a thickness gradient in one region or over its entire extent. This means in particular that the thickness of the side wall changes continuously in a direction away from the membrane, which may in particular be perpendicular to the main extension direction of the membrane. For example, the thickness of the side wall decreases continuously in this direction.

The membrane together with the housing form, in particular, an oscillation system. Preferably, the oscillation system is designed in such a way that the damping mode and the sending mode can be stably excited and are preferably natural modes of the oscillation system. This means that the membrane and the housing are preferably matched to each other in such a way that the sending mode and damping mode can be stably excited. In particular, at least one thickness of the side wall of the housing is adapted in such a way that the sending mode and the damping mode can be excited stably.

When the damping mode and/or sending mode is excited, the oscillation system can be set in motion or oscillation, at least partially. In particular, when the damping mode and/or sending mode is excited, the housing can be set in motion or oscillation, at least partially.

The design of the housing is preferably chosen so that, in addition to the sending mode, the damping mode is also stable. This can be achieved, for example, by the housing, as part of the oscillation system, having a side wall with several regions of different thicknesses. In other words, by forming the first region and the second region of the side wall of the housing, it is possible to achieve stable excitation of the sending mode and the damping mode.

The thicknesses of the side wall in the first and second regions are selected, for example, so that it is possible to stably excite both the sending mode without radiating an ultrasonic wave over a peripheral region of the membrane or side walls of the housing, and a stable damping mode. In the case of the damping mode, both a peripheral region of the membrane and/or the second region of the side wall are preferably excited. This means that the second region of the side wall, in which the side wall has a smaller thickness, can be set in motion or oscillation when the damping mode is excited.

The peripheral region of the membrane preferably completely surrounds a central region of the membrane. In a top view of the membrane, the peripheral region forms, for example, a ring-shaped or frame-shaped region surrounding the central region. In the peripheral region, the membrane can be in direct or indirect contact with the housing or the side wall of the housing.

The ultrasonic transducer may also comprise at least one piezoelectric element. For example, the actuating means and the damping means comprise the piezoelectric element for exciting the sending mode and the damping mode, respectively. In particular, the piezoelectric element converts an electrical signal into mechanical motion, by means of which the sending mode and the damping mode can be excited. The piezoelectric element may be a piezoelectric disc. In particular, the piezoelectric element may be part of the oscillation system. In this case, the piezoelectric element may be tuned with the other components of the oscillation system so that the damping mode and the sending mode can be stably excited.

To excite the sending mode, the membrane is excited during operation of the ultrasonic transducer, for example, with the sending frequency, in particular by the piezoelectric element. The sending frequency is, for example, between 50 kHz and 100 kHz, for example approximately 75 kHz. For this purpose, the piezoelectric element can be provided with an actuating signal. In other words, the actuating means is in particular configured to excite the membrane with the sending frequency.

To excite the damping mode, the membrane is excited, for example, with the damping frequency during operation of the ultrasonic transducer, in particular by the piezoelectric element. The damping frequency is, for example, between 200 kHz and 400 kHz, for example approximately 300 kHz. For this purpose, the piezoelectric element can receive a damping signal. In other words, the actuating means is specifically configured to excite the membrane with the damping frequency.

It is possible that the ultrasonic transducer and, preferably, at least one of the actuating means and damping means comprise controlling electronics. The controlling electronics provide, for example, a signal for the piezoelectric element.

It is possible that the piezoelectric element is connected to the controlling electronics of the ultrasonic transducer. For example, the controlling electronics comprise at least one of the following electronic components: a microcontroller, an application-specific integrated circuit, also known as “ASIC” for short, a field-programmable gate array, also known as “FPGA” for short.

The electronic component of the controlling electronics may be arranged on a carrier such as a circuit plate. The carrier or circuit plate may also be part of the oscillation system. In this case, the controlling electronics may be coordinated with the other components of the oscillation system in such a way that the damping mode and the sending mode can be stably excited. The controlling electronics can thus contribute to damping the ringing of membrane.

Preferably, the sending mode has a maximum in the central region of the membrane. In particular, the sending mode has an oscillation node in the peripheral region of the membrane and/or preferably at defined regions of the side walls of the housing. This means in particular that maxima and minima can alternate in the central region during membrane oscillation, so that the membrane in the central region is in motion during excitation by the actuating means. In the peripheral region, however, the membrane and/or, preferably, at the defined regions of the side walls of the housing, the oscillation system is preferably at rest during excitation of the sending mode. This reduces damping of the sending mode that can occur, for example, in the peripheral region and/or on the side wall of the housing due to edge effects or friction or movement of the housing. This allows the sending mode to be excited with comparatively low damping.

Furthermore, the damping mode preferably has a maximum in a peripheral region of the membrane. This means that the membrane is in motion in the peripheral region, i.e., at the edge, during damping of the ringing. This allows comparatively high dissipation or damping to be achieved for the damping mode or ringing.

Alternatively or additionally, the damping mode may have a maximum in a region of the side walls of the housing. The region of the side walls in which the damping mode exhibits a maximum is, for example, the second region or borders on the second region. This means that the side walls of the housing are in motion in certain regions during the damping of the ringing. This allows a comparatively high level of dissipation or damping to be achieved for the damping mode or ringing.

Preferably, a ratio of the thickness of the side wall in a region adjacent to the membrane to the membrane thickness is between 2 and 4, or preferably between 2.5 and 3.5, or more preferably 3 or approximately 3. The region of the side wall adjacent to the membrane is, for example, the first region. This ratio of the thickness of the side wall to the membrane thickness can suppress or prevent undesirable lateral radiation of an ultrasonic wave caused by oscillation of a peripheral region of the membrane in the region of the side wall.

The membrane of the ultrasonic transducer may have a freely oscillating surface of at least one square millimeter. This makes the membrane more robust and allows the ultrasonic transducer to be used under more unfavourable external conditions than, for example, a piezoelectric micromechanical ultrasonic transducer, which has a membrane with a surface area of less than one square millimetre.

The housing may comprise at least one damping element, which is preferably arranged in at least one region in which the damping mode has a maximum. In particular, the at least one damping element is arranged in a region in which the movement of the oscillation system has a maximum, for example during excitation of the damping mode.

The damping element may be, for example, a mechanical damper such as foam, for example polymer foam or silicone foam or the like. Alternatively or additionally, the damping element may comprise a silicone or a polymer as a solid material.

In particular, the damping element is configured to absorb and dissipate energy from the membrane oscillation. The damping element is therefore a dissipative element. The damping element can, for example, be arranged on a suspension of the membrane in the housing. Furthermore, the damping element may be arranged in a region that the membrane contacts during oscillation with the damping mode, but not during oscillation with the sending mode. Alternatively or additionally, an interior space of the housing may be filled with the damping element.

The damping element may, in particular, be part of the oscillation system. Thus, a material or an arrangement or a geometric shape of the damping element is preferably selected such that the sending mode and the damping mode can be stably excited and are preferably natural modes of the oscillation system.

The housing may in particular have at least two damping elements. A first of the damping elements may border the first region of the side wall and a second damping element may border the second region of the side wall. The first damping element and the second damping element preferably have different damping coefficients. For example, the first damping element has a lower damping coefficient than the second damping element.

The first damping element may fill a first part of the interior of the housing. The first part of the interior may be bounded in one direction, for example a lateral direction, by the first region of the side wall. The lateral direction is, in particular, a direction parallel to the main extension plane of the membrane. In a direction perpendicular to the lateral direction, the first damping element may be bounded by the membrane and the second damping element. In this case, the first damping element adjoins the membrane, for example. The first damping element comprises, for example, a foamed polymer or a silicone foam.

The second damping element may fill a second part of the interior of the housing. The second part of the interior may be bounded in the lateral direction by the second region of the side wall. In the direction perpendicular to the lateral direction, the second damping element may be bounded by the first damping element and a space outside the housing. The second damping element comprises, for example, a polymer or a highly cross-linked polymer or silicone as a solid material.

In particular, the first and second damping elements may comprise the same base material. The base material is, for example, silicone. For example, in the case of the first damping element, the base material is foamed, and in the case of the second damping element, the base material is present as a solid material.

Preferably, the second damping element is arranged in a region of the housing or side wall or the oscillation system that is in motion when the damping mode is excited. This allows energy from this motion to be effectively dissipated and the ringing of membrane to be effectively damped.

In a preferred embodiment of the ultrasonic transducer, the damping means is configured to excite the membrane with a damping signal. The damping signal preferably has a fixed part and a variable part. The damping means is further configured to excite the fixed part after exciting the membrane by the actuating means and to excite the variable part after the fixed part. For example, the fixed part follows the actuating signal directly, and the variable part follows the fixed part directly.

The controlling electronics provide the damping signal to the damping means, for example. The damping means is electrically conductively connected to the controlling electronics, for example.

In particular, the actuating means is configured to excite the membrane by means of an actuating signal. The actuating signal is provided, for example, by the controlling electronics. The actuating signal preferably essentially determines the ultrasonic wave emitted by the membrane and thus by the ultrasonic transducer. By specifying the actuating signal, the shape, length, frequencies, and so on of the ultrasonic wave can thus be determined.

The damping signal, in particular the fixed part of the damping signal, can be phase-shifted by 180° relative to the actuating signal. The phase shift of the damping signal enables efficient damping.

The actuating signal and the damping signal, in particular the fixed part of the damping signal, can have the same amplitude. This allows for particularly simple operation of the ultrasonic transducer, since the actuating signal and the damping signal can essentially be generated in the same way.

The damping means is preferably configured to excite the damping mode by means of the variable part of the damping signal. For example, during operation of the ultrasonic transducer, the fixed part of the damping signal dampens the amplitude of the ringing to such an extent that the damping mode can be excited by means of the variable part. This means, in particular, that the variable part excites the membrane at the damping frequency. This allows effective damping of the ringing of membrane by dividing the damping signal into a fixed part and a variable part.

In a further preferred embodiment or according to one of the other embodiments described above, the ultrasonic transducer comprises a detecting means and an adapting means. The detecting means is in particular configured to detect at least one swinging parameter of the ringing during excitation of the fixed part of the damping signal. The adapting means is then specifically configured to determine the variable part of the damping signal during excitation of the fixed part on the basis of the detected swinging parameter. The swinging parameter can be an amplitude of the ringing of membrane or an amplitude of a specific frequency component of the ringing.

In particular, the variable part is determined or adjusted during operation of the ultrasonic transducer. For example, the variable part is optimized with respect to the detected swinging parameter. For example, the optimization is performed using an optimization algorithm such as a population algorithm or using the least squares method. It is also possible that the optimization of the variable part is performed using an AI method. The optimization is preferably performed on the controlling electronics. This means that the controlling electronics are configured to perform the optimization.

The adapting means and the detecting means may be part of the controlling electronics and integrated therein.

The adapting means may further be configured to determine the fixed part of the damping signal before the membrane is excited by the actuating means. For example, the fixed part is determined before a distance measurement is performed using the ultrasonic transducer. It is also possible for the fixed part to be determined once for multiple distance measurements. This saves computing time during operation of the ultrasonic transducer and enables effective optimization of the damping signal with regard to the ringing. The fixed part can be stored in a memory unit of the control electronics and retrieved by the adapting means during operation of the ultrasonic transducer.

The actuating means is specifically configured to determine the fixed part of the damping signal using a population algorithm. Alternatively, the fixed part can also be determined using an AI method. For the population algorithm, for example, an amplitude of the ringing, in particular at a fixed point in time during the ringing, is used as a fitness parameter. Alternatively, the amplitude of a specific frequency component of the ringing can be selected as the fitness parameter. The population algorithm is executed in particular on the controlling electronics. This means that the controlling electronics are configured to execute the population algorithm.

In particular, in a population algorithm such as in the present embodiment, a population with a plurality of individuals is generated randomly or pseudo-randomly, each individual corresponding to a damping signal or a fixed part of the damping signal. A degree of adaptation or fitness of the individual individuals is then determined by damping a ringing with each damping signal and comparing the amplitude of this ringing with the fitness parameter. Preferably, all individuals whose fitness does not reach a predefined value are subsequently deleted. For example, all individuals that deviate from the fitness parameter by more than 10% are deleted.

In a further random step, a new generation of individuals is generated from the remaining individuals, which may differ randomly from the previous generation in some parameters within a fixed interval of, for example, 10%. This generation of individuals is then tested for fitness as described above. By repeating the steps of generating a new generation, determining the fitness of the new generation, and then selecting, an optimized damping signal or an optimized fixed part or variable part can be obtained.

It is possible that the damping signal comprises at least one damping pulse. The adapting means is specifically configured to set a plurality of the following parameters for the fixed part of the damping signal and exactly one of the following parameters for the variable part of the damping signal: number of damping pulses, width of the at least one damping pulse, sequence of the at least one damping pulse, amplitude of the damping pulse.

For example, the adapting means is configured to determine the number of damping pulses, the sequence of the damping pulses, and the width of the damping pulses, in particular for the fixed part. Furthermore, in this example, the adapting means is configured to set and optimize the sequence or temporal position of the damping pulses for the variable part of the damping signal. Thereby, the parameters set for the fixed part are preferably adopted for the variable part.

If all of the above parameters for the damping signal are to be optimized, this results in a relatively large parameter space in which the optimal parameters must be found. Depending on the parameters and the optimization method used, this can be computationally intensive and take up to several minutes. By dividing the damping signal into a fixed part and a variable part, the fixed part can be optimized in the relatively large parameter space before the ultrasonic transducer is used for measurement.

The variable part can then be dynamically optimized during measurement operation of the ultrasonic transducer using a single parameter. This optimization has the advantage of a significantly smaller parameter space and can therefore be performed much faster. In particular, it is possible for the variable part to be determined and optimized during the provision of the fixed part of the damping signal. Therefore, the damping of the ringing can be performed effectively and optimized during operation of the ultrasonic transducer.

A width of the at least one damping pulse is determined in particular based on the time during which the damping signal exhibits the damping pulse. For example, the damping pulses are rectangular pulses. This means that during the time in which the damping signal exhibits the damping pulse, the damping signal has a predetermined voltage that is not equal to zero. The time period during which the damping signal exhibits this voltage determines, in particular, the width of the damping pulse.

If, for example, the damping signal exhibits only one damping pulse, the sequence of the one damping pulse can indicate the time period after the excitation of the membrane with the actuating means has ended at which the damping pulse occurs. In case that the damping signal comprises several damping pulses, the sequence indicates, for example, alternatively or additionally, in the temporal sequence in which the damping pulses follow one another in the damping signal.

The width of the at least one damping pulse may, for example, be between 0.002 milliseconds and 0.1 milliseconds, inclusive.

The damping signal comprises, for example, between two and 20 damping pulses, inclusive.

For example, a time interval between two damping pulses is between 0.002 milliseconds and 0.1 milliseconds, inclusive. In this case, the damping signal has at least two damping pulses in particular.

A waiting period between the end of excitation of the membrane with the actuating means and a first damping pulse of the damping signal can be between 0.002 milliseconds and 0.1 milliseconds, inclusive. The waiting period is thus measured, for example, from a time between the end of the actuating signal and the first occurrence of a damping pulse of the damping signal. The sequence of the damping pulses is determined in particular by the waiting period and the time interval between the damping pulses.

In case that the damping signal comprises at least two damping pulses, the damping pulses of the damping signal preferably have the same amplitude. For example, the damping pulses are generated by switching a damping voltage on and off. The damping voltage is constant and varies only in sign, for example. This makes the damping signal particularly easy and therefore inexpensive to generate, as no adjustment of the amplitude is necessary.

Alternatively or additionally, the damping pulses have a same pulse shape. For example, the damping pulses are rectangular pulses. The damping pulses preferably differ from each other only in their width and sign.

In a further embodiment or according to one of the embodiments described above, the ultrasonic transducer comprises at least one ambient sensor. The ambient sensor is configured to detect at least one ambient parameter. The ambient parameter can be an ambient temperature of the environment of the ultrasonic transducer or a relative humidity or the like. In particular, ambient parameters that can influence the functionality or operation of the ultrasonic transducer are of interest. The ambient sensor can be, for example, a temperature sensor and/or a humidity sensor.

The ambient sensor is preferably connected to the controlling electronics or may be integrated into the controlling electronics. For example, the ambient parameter or ambient parameters may be stored in a memory unit of the controlling electronics.

The adapting means may also be configured to determine the fixed part of the damping signal taking into account the ambient parameter. For example, the fixed part may be redetermined when the temperature and/or humidity of an environment of the ultrasonic transducer changes.

It is also possible for the fixed part to be determined for a plurality of ambient parameters prior to the measuring operation of the ultrasonic transducer and stored in the memory unit of the controlling electronics as a function of the ambient parameter. Then, the fixed part can be quickly adjusted when the ambient parameter changes. In this case, the ultrasonic transducer preferably includes controlling electronics with a memory unit.

The memory unit may have several registers in this and in all other embodiments. For example, the memory unit is configured to store an ambient parameter in one register and the fixed part of the damping signal in another register. The variable part of the damping signal can also be stored in a further register.

According to at least one embodiment or one of the embodiments described above, the adapting means is configured to store the variable part of a first damping signal in a second register of the memory unit. The detecting means is preferably configured to detect a second swinging parameter of the ringing during the application of a fixed part of a second damping signal. The adapting means is further configured in particular to determine a variable part of the second damping signal following the first damping signal based on the stored variable part of the first damping signal and the detected second swinging parameter. The damping means is preferably further configured to apply the second damping signal to the membrane. In this case, a ringing of the membrane damped by the first damping signal exhibits a phase shift of, for example, 180° relative to a ringing of the membrane damped by the second damping signal.

The first damping signal preferably follows the second damping signal directly. For example, the membrane is excited to emit a first ultrasonic wave. The ringing of this excitation is damped by means of the first damping signal. Subsequently, a first reflected wave is detected for distance measurement. The membrane is then excited to emit a second ultrasonic wave, whereby the ringing of this excitation is damped by means of the second damping signal. A second reflected wave is then detected for distance measurement. Here and in the following, “first” and “second” do not refer to the absolute first excitation or damping in the overall operation of the ultrasonic transducer but are merely intended to relate two excitation and damping processes to each other.

Despite the damping of the ringing of membrane, the membrane may exhibit a slight oscillation during operation of the ultrasonic transducer when detecting a reflected wave, which is superimposed on the reflected wave. Depending on the phase relationship between the ringing of membrane and the reflected wave, the ringing of membrane and the reflected wave may superimpose constructively or negatively. In the first case, the oscillation amplitude of the membrane increases, and in the second case, the oscillation amplitude of the membrane decreases, for example to zero. In both cases, the arrival of the reflected wave can be detected by a change in amplitude.

However, it is also possible that the phase relationship between the ringing and the reflected wave is such that the amplitude of the membrane does not change. For example, the ringing and the amplitude then have a phase shift of ⅔ π or 120°. In this case, the arrival of the reflected wave cannot be determined because no change in amplitude can be detected.

To rule out this case, the second damping signal can be adjusted so that the ringing following the first excitation and the ringing following the second excitation are phase-shifted by π or 180°.

In many applications of the ultrasonic transducer, for example in the automotive region, the intervals between two measurement cycles consisting of emitting an ultrasonic wave and detecting the reflected wave are so short that it can be assumed with a good degree of accuracy that the first reflected wave and the second reflected wave have identical phases. This means that if the first or second ringing interferes with the reflected waves in such a way that no change in amplitude can be detected, the change in amplitude can be determined from the interference with the other reflected wave. If measurement results can be determined from both measurement cycles, these can be averaged to increase the accuracy of the measurement results.

A phase shift of 180° between the first ringing and the second ringing is achieved in particular by storing the variable part of the first damping signal in the memory unit. The variable part of the first damping signal is determined, for example, on the basis of an amplitude of the damping mode as the first swinging parameter.

Subsequently, a second swinging parameter, for example an amplitude, is recorded during the fixed part of the second damping signal. The first and second swinging parameters may be different from each other. The first and second swinging parameters may, for example, be an amplitude of the membrane oscillation at a fixed point in time or an amplitude of a specific frequency component of the membrane oscillation.

The variable part of the second damping signal is determined based on the stored variable part of the first damping signal and the detected second swinging parameter. For example, to determine the variable part of the second damping signal, the amplitude of the membrane is superimposed with the variable part of the first damping signal. This method can achieve a phase shift of 180° between the first ringing and the second ringing.

Preferably, the first damping signal and the second damping signal have a common fixed part. The fixed part is stored, for example, in a first register of the memory unit.

Moreover, embodiments provide a method for operating an ultrasonic transducer. The ultrasonic transducer described here can be operated in particular using the method for operating an ultrasonic transducer. This means that all features disclosed for the ultrasonic transducer are also disclosed for the method and vice versa.

Embodiments provide a method for operating an ultrasonic transducer comprising a membrane in a housing, wherein the method comprises the following steps:
Exciting the membrane to emit an ultrasonic wave, wherein a membrane oscillation comprising a stable sending mode with a sending frequency is excited,
Damping a post-excitation ringing, wherein a membrane oscillation comprising a stable damping mode with a damping frequency is excited, wherein the damping frequency and the sending frequency are different.

These steps are performed in particular in the order specified. Preferably, these steps are performed several times in succession.

In particular, the method achieves the advantages and effects explained above in connection with the embodiments of the ultrasonic transducer.

In one embodiment of the method, the damping of the ringing is achieved by applying a damping signal, wherein the damping signal comprises a fixed part and a variable part. The variable part follows the fixed part in time. The fixed part is determined in particular before the excitation of the sending mode. The variable part is preferably determined dynamically on the basis of at least one parameter of the ringing, which is determined during the application of the fixed part. As described above, dividing the damping signal into a fixed part and a variable part can reduce the computing time required to optimize the damping signal and enable effective damping.

In a further embodiment of the method or one of the embodiments described above, the membrane is excited multiple times to emit an ultrasonic wave, with damping by means of the damping signal is performed between two excitations. The fixed part of the damping signal is determined before the membrane is excited multiple times. The variable part of the damping signal is determined during the damping of the ringing based on at least one swinging parameter of the ringing.

This means that the variable part is continuously optimized and adjusted during operation of the ultrasonic transducer. To adjust the variable part, fewer parameters, in particular only one parameter, of the damping signal are optimized. This reduces the parameter space that must be optimized during operation of the ultrasonic transducer compared to optimization of the entire damping signal. This thus enables optimization of the damping signal during operation of the ultrasonic transducer.

In a further embodiment of the method or one of the embodiments described above, during damping of a first ringing with a first damping signal, the variable part of the first damping signal is stored in a second register of a memory unit. During subsequent damping of a second ringing with a second damping signal, a second swinging parameter of a second ringing is detected and the variable part of the second damping signal is determined on the basis of the detected second swinging parameter and the stored variable part of the first damping signal, so that the first ringing is phase-shifted by 180° relative to the second ringing.

With this method, it is possible, as described above, to obtain a measurement signal independent of the phase relationship between the first ringing of the membrane and the reflected wave in the event that the ringing has not completely decayed after damping. The reason for this is that even if no changes in the amplitude of the membrane oscillation can be detected due to the phase relationship between the first ringing and the reflected wave, the reflected wave causes a change in amplitude having the second ringing because the first and second ringing have a fixed phase relationship to each other. The phase relationship between the first and second ringing is preferably achieved as described above.

Moreover, embodiments provide a method for measuring distance. The method for measuring distance uses an ultrasonic transducer described herein, which is operated in particular using a method for operating an ultrasonic transducer described herein. This means that all features disclosed for the method for operating the ultrasonic transducer and all features disclosed for the ultrasonic transducer are also disclosed for the method for measuring distance, and vice versa.

Preferably, exactly one ultrasonic transducer is used in the method for measuring distance. This means that the ultrasonic transducer serves both as a transmitting element for an ultrasonic wave and as a detection element for an ultrasonic signal reflected by the object to be measured.

In a transmission operation, the method for measuring distance includes, for example, an ultrasonic signal, such as an ultrasonic wave, being emitted as a pulse from the ultrasonic transducer. After the pulse hits an object, it is at least partially reflected back. In a receiving operation, this reflected pulse is detected, allowing the transit time to be determined. Since ultrasonic signals propagate at known speeds in both air and water, the transit time can be used to calculate the distance to the target being measured.

If the distance to the object is short, for example less than 10 cm, the ringing of the membrane of conventional ultrasonic transducers typically continues to occur after the pulse has been emitted, which is why such ultrasonic transducers often cannot be used simultaneously as transmitting and receiving elements.

With the ultrasonic transducer described here, it is possible to measure even particularly short pulse transit times, i.e., particularly short distances, with only a single ultrasonic transducer, since effective damping of the ringing of membrane is achieved.

In particular, the distance measurement method can be used to measure objects at a distance of between 4 cm and 2 m inclusive. In particular, distances of less than 10 cm are measured.

### BRIEF DESCRIPTION OF THE DRAWINGS

Further advantages and advantageous designs and further developments of the method for operating an ultrasonic transducer and the ultrasonic transducer will become apparent from the exemplary embodiments described below in connection with schematic drawings. Identical, similar, and equally effective elements are designated by the same reference numerals in the figures. The figures and the relative sizes of the elements shown in the figures are not necessarily to be regarded as to scale. Rather, individual elements may be exaggerated in size for better representation and/or better understanding.

FIGS. 1 to 3 show an ultrasonic transducer described herein according to an exemplary embodiment;

FIG. 4 shows an illustration of a sending mode;

FIG. 5 shows an illustration of a damping mode;

FIG. 6 shows a graphical representation of an impedance of an ultrasonic transducer described herein according to the exemplary embodiment;

FIGS. 7 to 11 show sectional views of an ultrasonic transducer described herein according to several exemplary embodiments;

FIG. 12 shows an example of an actuating signal, and a damping signal as used in the method described herein;

FIG. 13 shows possibilities for adjusting a damping signal as used in the method described herein;

FIG. 14 shows schematic representation of a method described here for operating an ultrasonic transducer according to a first exemplary embodiment;

FIG. 15 shows a graphical representation of a ringing of a membrane damped with a damping signal described herein, compared to a membrane without a damping signal;

FIG. 16 shows a graphical representation of a frequency analysis of the ringing of a membrane damped with a damping signal described herein, compared to a membrane without a damping signal;

FIG. 17 shows a graphical representation of a signal of a damped membrane displacement;

FIGS. 18 and 19 show graphical representations of signals of a reflected wave that was reflected by an object to be measured and received by the ultrasonic transducer;

FIG. 20 shows a schematic representation of a method described herein for operating an ultrasonic transducer according to a second exemplary embodiment; and

FIGS. 21 to 25 are illustrations of a superposition of reflected waves and ringing.

### DETAILED DESCRIPTION OF ILLUSTRATIVE EMBODIMENTS

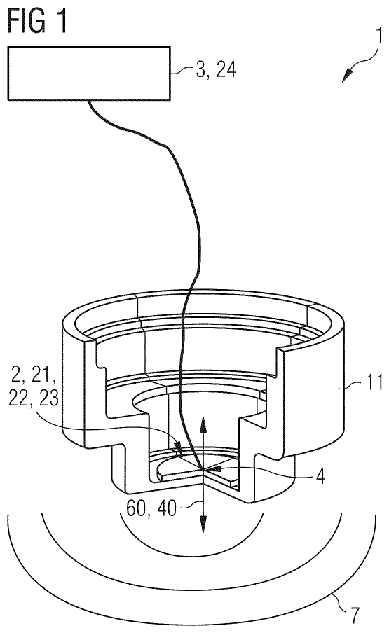

The ultrasonic transducer 1 according to FIGS. 1 to 3 comprises an actuating means 21, a damping means 22, a detecting means 23, and an adapting means 24. The actuating means 21, the damping means 22, and the detecting means 23 comprise a piezoelectric element 2. The adapting means 24 comprises controlling electronics 3. The controlling electronics 3 are configured to excite a membrane 4 coupled to the piezoelectric element 2. Due to excitation, the membrane 4 can perform a movement 60. The piezoelectric element 2 and the membrane 4 are arranged in a housing 11. It is possible that the controlling electronics 3 are also arranged in the housing 11. The controlling electronics 3 comprise, for example, an application-specific integrated circuit (ASIC) or are integrated in an application-specific integrated circuit.

The actuating means 21 can excite the membrane 4 with an actuating signal 6 so that an ultrasonic wave 7 is emitted. After the ultrasonic wave 7 is emitted, the membrane 4 typically continues to oscillate, i.e., it continues to perform a ringing 40.

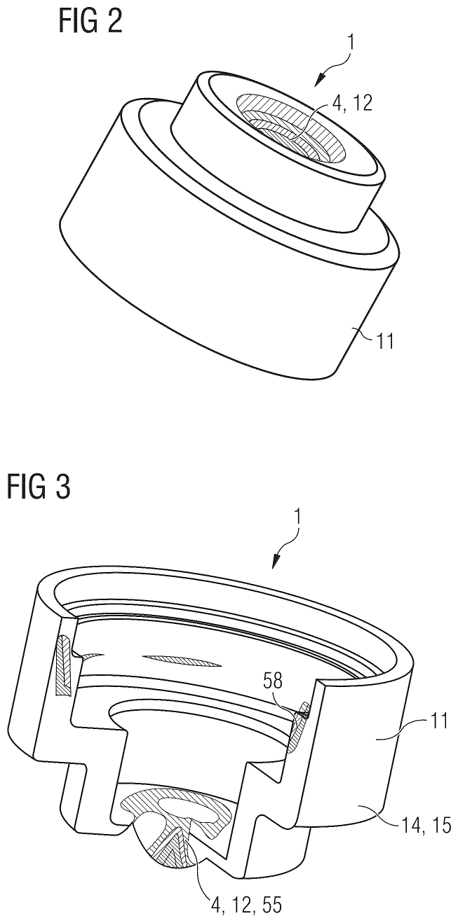

When excited to emit the ultrasonic wave 7, the membrane 4 is excited to oscillate in a sending mode 12. The sending mode 12 is a natural mode of the ultrasonic transducer 1 and has a maximum in a central region of the membrane 4 (compare FIGS. 2 and 4). Oscillation nodes of the sending mode 12 are preferably located in a peripheral region or at the edge of the membrane. As a result, the sending mode 12 preferably has low damping.

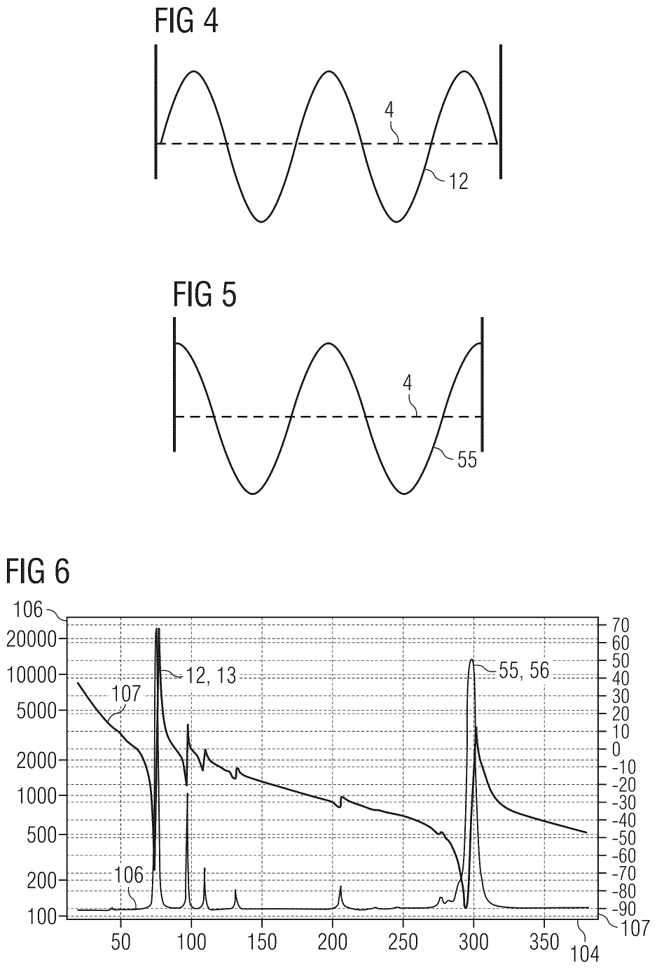

To dampen the ringing 40, the damping means 22 excites the membrane 4 to oscillate with a damping mode 55. The damping mode 55 has a significantly higher damping than the oscillation mode 12. In particular, the damping mode 55 comprises a maximum in a peripheral region or at the edge of the membrane 4 (compare FIGS. 3 and 5), whereby the damping mode 55 has high dissipation or damping.

The housing 11 of the ultrasonic transducer 1 is a rotationally symmetrical pot housing and, for example, together with the membrane 4, the piezoelectric element 2, and the damping element 10, forms an oscillation system. The housing 11 and/or other elements of the oscillation system are adapted in such a way that the sending mode 12 and the damping mode 55 can be excited stably and are preferably natural modes of the ultrasonic transducer 1. For this purpose, the housing 11 has, for example, a side wall 14 with a thickness 15.

A stable damping mode 55 allows energy from the ringing 40 to be effectively dissipated, and the ringing 40 can be effectively damped.

In particular, when a damping mode 55 is excited, part of the housing 11 oscillates along with it. This means that the oscillation system is partially in motion. The oscillation system exhibits housing movement 58, particularly at the side wall 14. The housing movement 58 can further dampen the ringing 40.

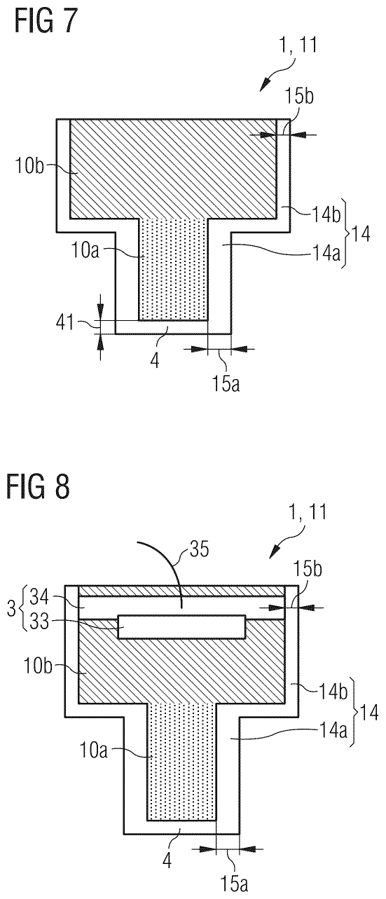

FIG. 6 illustrates an impedance of the ultrasonic transducer 1 according to the present exemplary embodiment. In FIG. 6, both the real part of the impedance 106 and the imaginary part of the impedance 107 are plotted as a function of a frequency 104 in kHz. The frequency 104 is an oscillation frequency of the membrane 4. Both in the real part 106 and in the imaginary part 107, the sending mode 12 and the damping mode 55 can be recognized as resonance modes or normal modes of the membrane 4. The sending mode 12 has a sending frequency 13 of approximately 75 kHz. The damping mode 55 has a damping frequency 56 of approximately 300 kHz.

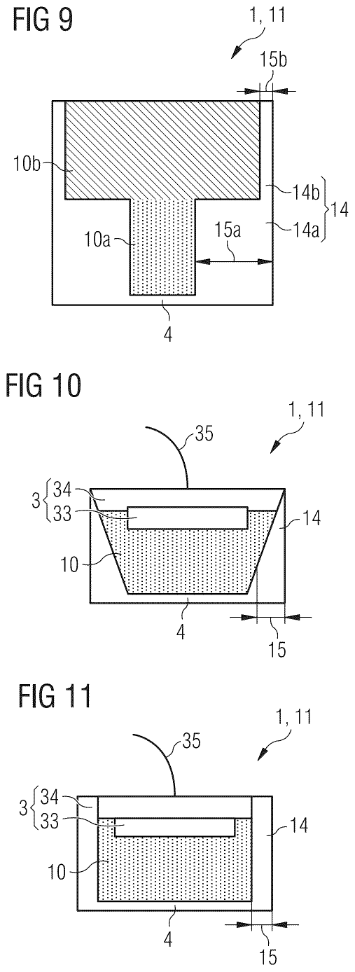

FIGS. 7 to 11 show cross-sectional views of an ultrasonic transducer 1 described herein according to several exemplary embodiments. A sectional plane runs perpendicular to a main extension plane of a membrane 4 of the respective ultrasonic transducer 1. The ultrasonic transducers 1 according to FIGS. 7 to 11 are based in particular on the same functional principles and effects as the ultrasonic transducer 1 according to FIG. 1. Therefore, the ultrasonic transducers 1 according to FIGS. 7 to 11 in particular also comprise actuating means 21, damping means 22, detecting means 23 and adapting means 24, as well as controlling electronics 3 and a piezoelectric element 2. For the sake of simplicity, only the differences and special features of the ultrasonic transducers of FIGS. 7 to 11 compared to the ultrasonic transducer of FIG. 1 will be described below.

The ultrasonic transducer 1 according to FIG. 7 comprises a membrane 4 and a housing 11. The housing 11 has a side wall 14 that extends perpendicular to the main plane of the membrane 4. The housing is rotationally symmetrical.

The side wall 14 has a first region 14a with a thickness 15a. Furthermore, the side wall 14 has a second region 14b with a thickness 15b. The thickness 15a of the side wall 14 in the first region 14a is greater than the thickness 15b of the side wall 14 in the second region 14b.

The thicknesses 15a, 15b of the side wall 14 are selected in particular such that the sending mode 12 and the damping mode 55 can be excited stably.

The housing 11 with the side wall 14 is in particular part of an oscillation system in which the membrane 4 also included. When the damping mode 55 is excited, part of the oscillation system can be set in motion or oscillation. In particular, the second region 14b of the side wall 14 can perform a housing movement 58.

An interior space of the housing 11 is filled with a first damping element 10a and a second damping element 10b. The first damping element 10a is adjacent to the membrane 4 and to the first region 14a of the side wall 14. The second damping element 10b is adjacent to the first damping element 10a and to the second region 14a of the side wall 14. The first damping element 10a is a silicone foam, for example, an expanded silicone. The second damping element 10b is a solid silicone material. Thus, the second damping element 10b has a higher damping coefficient than the first damping element 10a.

The second damping element 10b is advantageously arranged adjacent to the second region 14b. In this region 14b, excitation of the damping mode 55 causes excitation of the housing movement 58. This allows energy from the damping mode 55 to be effectively dissipated.

FIG. 7 further illustrates that the membrane 4 has a membrane thickness 41. A ratio of the thickness 15a of the side wall 14 in the first region 14a to the membrane thickness 41 is preferably 3. This ratio of the thickness 15a of the side wall 14 to the membrane thickness 41 suppresses undesirable lateral radiation of an ultrasonic wave caused by oscillation of a peripheral region of the membrane 4 in the region of the side wall 14.

In contrast to FIG. 7, the controlling electronics 3 of the ultrasonic transducer 1 according to FIG. 8 comprises a circuit plate 34 on which an integrated circuit 33 is arranged. The integrated circuit 33 is in particular an ASIC. The controlling electronics 3 can be electrically contacted and controlled during operation by means of a line 35.

The circuit plate 34 and the integrated circuit 33 are arranged at least partially inside the housing 11. For example, the circuit plate 34 is suspended in the second region 14b of the side wall 14. The circuit plate 34 and the integrated circuit 33 are thus part of the oscillation system. This allows the circuit plate 34 and the integrated circuit 33 to be set in motion when the damping mode 55 is excited and to contribute to damping the ringing 40 of the membrane 4. Furthermore, the circuit plate 34 and the integrated circuit 33 are preferably adapted in such a way that the damping mode 55 and the sending mode 12 can be excited stably.

Compared to FIG. 7, the first region 14a of the side wall 14 of the housing 11 of the ultrasonic transducer 1 in FIG. 9 has a greater thickness 15a. The thickness 15a is such that the side wall 14 has a straight outer surface. The outer surface of the side wall 14 is a side of the side wall 14 that faces away from the interior of the housing 11 and is accessible from the outside. This means that the outer surface does not have a step.

In contrast to FIG. 8, the ultrasonic transducer 1 of FIG. 10 has only one damping element 10. The damping element 10 is a silicone foam.

Furthermore, the side wall 14 has a thickness gradient. This means, in particular, that the thickness 15 of the side wall 14 decreases continuously in a direction away from the membrane 4. The thickness gradient is selected in particular so that the damping mode 55 and the sending mode 12 can be excited stably.

In contrast to FIG. 10, the ultrasonic transducer 1 in FIG. 11 does not have a thickness gradient. The side wall 14 has a uniform thickness 14. The thickness 14 is adapted in particular such that the damping mode 55 and the sending mode 12 can be excited stably.

In the ultrasonic transducers 1 of FIGS. 10 and 11, the damping mode 55 preferably excites no or only insignificant housing movement. The damping of the ringing 40 is achieved in particular by a movement of the membrane 4 in the peripheral region of the membrane 4. Thus, the damping is achieved in particular by friction at the edge of the membrane 4.

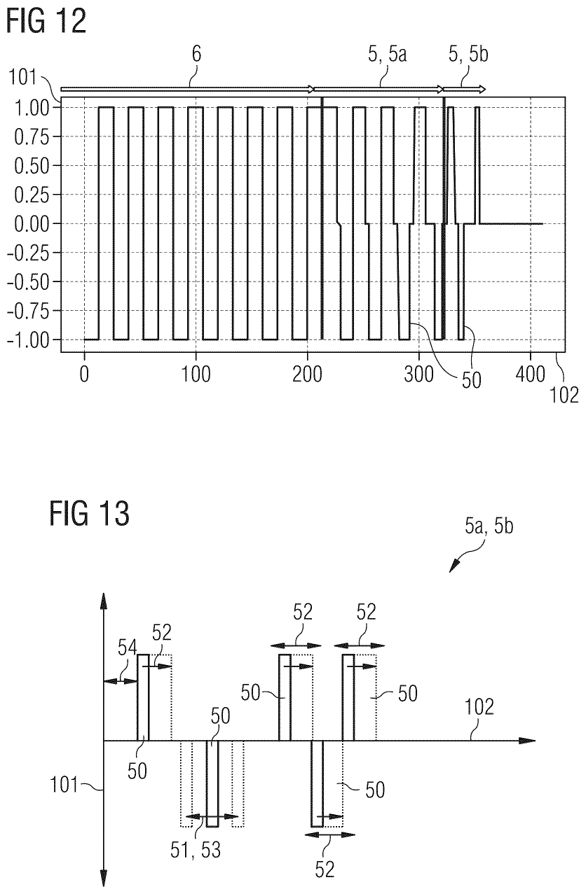

To dampen the ringing of membrane 40, a damping signal 5 can be applied to the ultrasonic transducer 1 according to one of the above exemplary embodiments, which follows the actuating signal 6 for exciting the sending mode 12, as illustrated in FIG. 12. The actuating signal 6 comprises rectangular pulses that are applied in temporal sequence 102 with a voltage 101. The voltage 101 has a fixed amplitude, with the sign changing after each square pulse.

In order to dampen the ringing 40 of the membrane 4, the controlling electronics 3 provide the damping signal 5 for the damping means 22. The damping signal 5 comprises at least one damping pulse 50. The controlling electronics 3 are configured to determine at least one parameter of the damping signal from the following parameters: number 51 of damping pulses, width 52 of damping pulses 50, and sequence 53 of damping pulses 50. The damping signal 5 follows the actuating signal 6 immediately. This means that there is no waiting period between the actuating signal 6 and the damping signal 5.

The damping signal 5 comprises a fixed part 5a and a variable part 5b that follows the fixed part 5a. To determine the fixed part 5a, several of the above-mentioned parameters of the damping signal 5 are determined, for example. The fixed part 5a is preferably determined before the actuating signal 6 is provided, based on a swinging parameter 8 of the ringing 40. The swinging parameter 8 is, for example, an amplitude of the ringing 40 at a specified point in time. By determining a plurality of parameters, the parameter space that needs to be optimized is relatively large and the determination of the fixed part 5a is time-consuming. By defining the fixed part 5a before providing the actuating signal 6, time-consuming optimization after excitation of the membrane can be omitted.

The fixed part 5a of the damping signal 5 is specifically configured to reduce the amplitude of the ringing 40. The variable part 5b is specifically provided to excite the damping mode 55.

For the variable part 5b, only one of the above-mentioned parameters is determined and optimized, while the other parameters are taken over from the fixed part 5a. This means that the parameter space to be optimized is much smaller, and optimization of the variable part 5b can take place during the provision of the fixed part 5b.

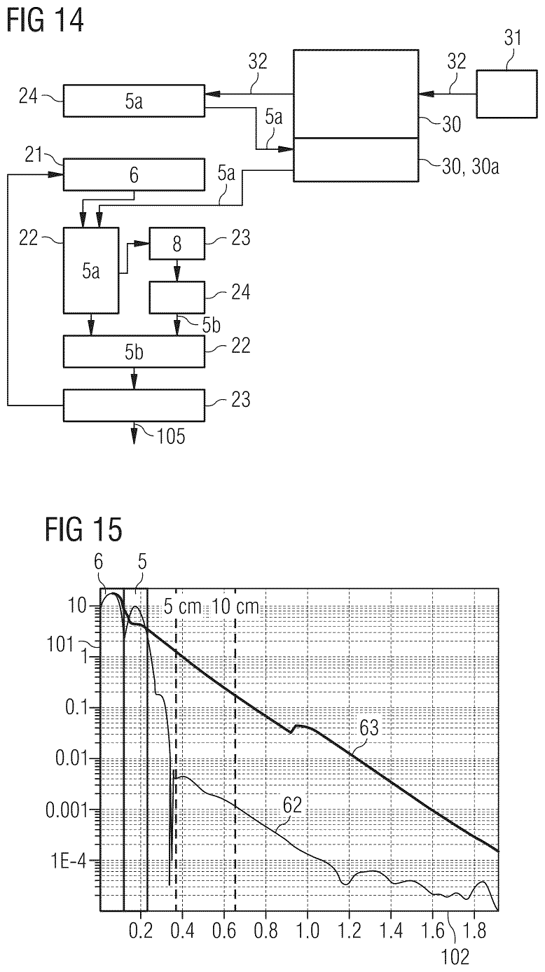

FIG. 13 illustrates possibilities for adjusting the damping signal 5 as used in the method described here for operating an ultrasonic transducer 1. Both the fixed part 5a and the variable part 5b of the damping signal 5 can be adjusted according to the possibilities shown in FIG. 13, whereby preferably only one possibility for adjustment is selected for the variable part 5b. The damping signal 5 comprises a plurality of damping pulses 50, all of which have the same amplitude. The signs of the damping pulses 50 may vary and are determined, for example, by the controlling electronics 3.

The controlling electronics 3 determine, for example, the width 52 of the damping pulses 50. The width 52 results from the time 102 during which the voltage 101 is applied.

Furthermore, the number 51 of damping pulses 50 is determined by the controlling electronics, as is a sequence 53 of the damping pulses 50. The sequence 53 of the damping pulses 50 specifies the temporal sequence in which the damping points 50 occur in the damping signal 5. Furthermore, the sequence 53 specifies after which waiting period 54 a first damping pulse 50 occurs in the damping signal 5.

For example, the sequence 53 is optimized for the variable part 5b.

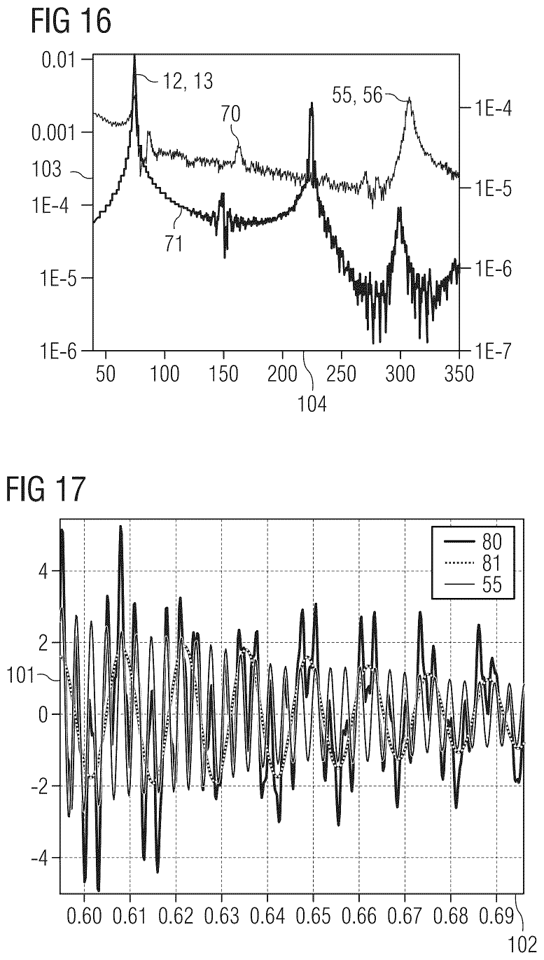

FIG. 14 illustrates a method described here for operating an ultrasonic transducer according to a first exemplary embodiment. The method can be executed on the controlling electronics 3. The method comprises determining the fixed part 5a of the damping signal 5 by means of the adapting means 24. The fixed part 5a is determined, for example, by means of an optimization algorithm such as a population algorithm. The fixed part 5a is stored in a memory unit 30 of the controlling electronics 3. For example, the fixed part 5a is stored in a first register 30a of the memory unit 30.

Optionally, the fixed part 5a is additionally determined on the basis of an ambient parameter 32. The ambient parameter 32 is, for example, an ambient temperature and is determined using an ambient sensor 31, for example a temperature sensor. The ambient parameter 32 can be stored in the memory unit 30.

During operation of the ultrasonic transducer, the membrane 4 is excited by means of the actuating means 21 and the actuating signal 6. After the ultrasonic wave 7 is emitted, the ringing 40 is damped by means of the damping means 22 and the fixed part 5a of the damping signal 5 in order to reduce an amplitude of the ringing 40. Thereby, a swinging parameter 8, for example an amplitude of the ringing 40, is detected by the detecting means 23 and the variable part 5b of the damping signal 5 is determined by means of the adapting means 24. For this purpose, a parameter of the damping signal 5 can be optimized during providing the fixed part 5a.

Subsequently, the variable part 5b is provided and the ringing 40 is further damped by means of the damping means 22. In particular, the damping mode 55 is excited and the ringing 40 is effectively damped.

A reflected wave is then detected by the detecting means 23. The distance 105 to an object can be calculated from the time interval between the transmission of the ultrasonic wave 7 and the detection of the reflected wave and output as the result of a distance measurement.

Subsequently, the transmission of an ultrasonic wave 7 can be stimulated again and a new distance 105 can be determined. Thereby, the procedure just described is repeated, whereby the fixed part 5a of the damping signal 5 is not calculated at each repetition but is retrieved from the first register 30a by the damping means 22.

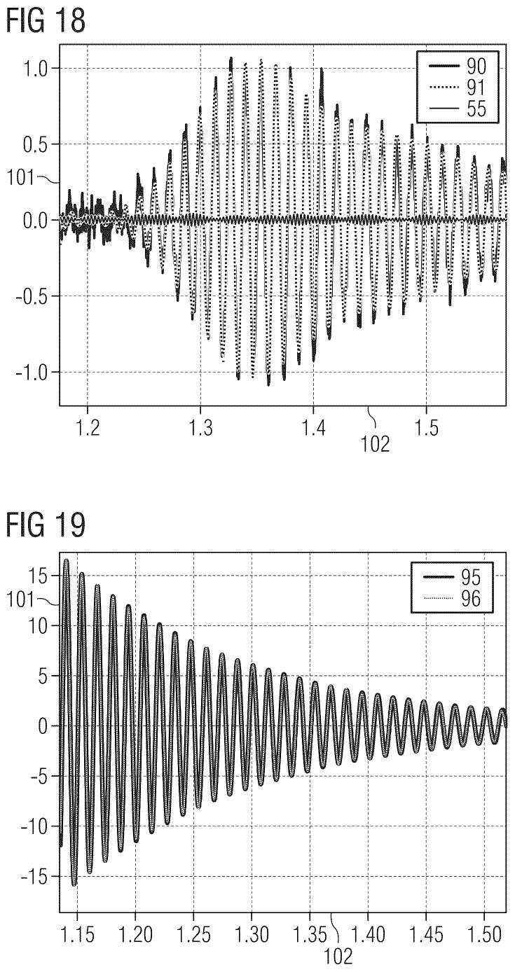

FIG. 15 shows the signal of a membrane displacement 62 of a membrane 4, which is damped using a method described here, in comparison to a comparative example of a membrane displacement signal 63 that is not damped. The membrane displacements can be converted via the piezoelectric effect into a voltage 101 (specified in V), which is plotted in FIG. 4 as a function of time 102 (specified in ms). During excitation with the actuating means 21, a voltage 101 associated with both membrane displacements 60, 61 is greater than 10 V. The actuating signal 6 lasts for approximately 0.1 ms.

The actuating signal 6 is immediately followed by the damping signal 5 in the case of membrane displacement 60. The damping signal 5 lasts approximately 0.1 ms. A comparison of the voltage 101 curves for the damped membrane displacement 60 and the undamped membrane displacement in the comparative example shows that the voltage 101 for the damped membrane displacement 60 is approximately two orders of magnitude lower than the voltage 101 in the comparative example from approximately 0.4 ms onwards. The damping signal 5 thus effectively dampens the membrane displacement 60.

Dotted vertical lines in FIG. 10 illustrate times at which, after an ultrasonic wave 7 is emitted from the ultrasonic transducer 1 to an object 5 cm or 10 cm away, a wave reflected from the object reaches the ultrasonic transducer 1 again. A relationship between distance 105 and time results from the speed of sound of the ultrasonic wave 7. For both an object at a distance of 5 cm and an object at a distance of 10 cm, the voltage 101 associated with the damped membrane displacement 60 is approximately two orders of magnitude smaller than the voltage 101 associated with the undamped membrane displacement 61. This means that the distance to these objects can be effectively determined using a damped membrane displacement 60 by means of the ultrasonic transducer.

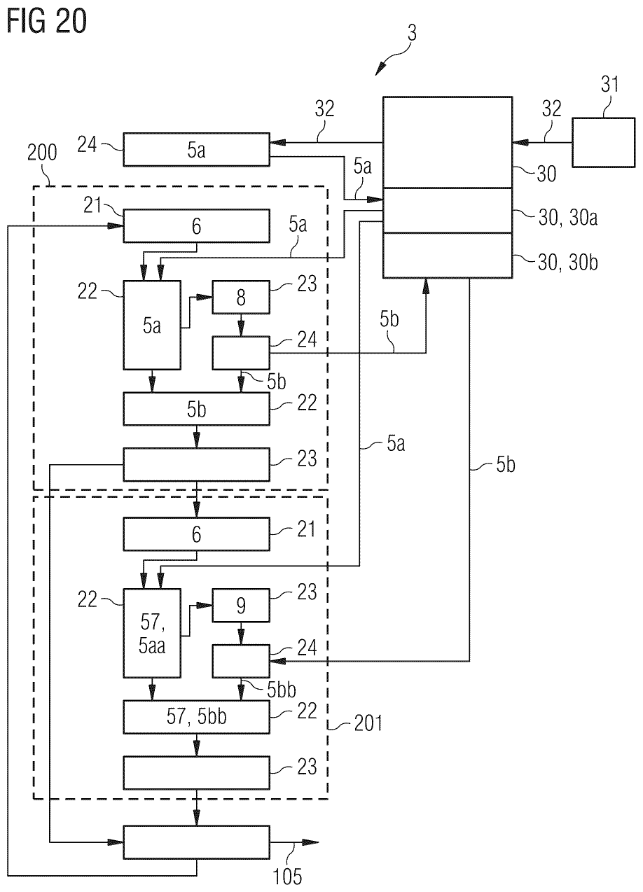

FIG. 16 illustrates which frequency components are present in the ringing 40 of the membrane 4 when the damping signal 5 is applied and in a comparative example in which no damping signal 5 is applied. The amplitude 103 of an oscillation signal, which is obtained in particular from the membrane displacements 60, 61, is shown as a function of the frequency 104 (given in kHz). When the ringing 40 is damped (compare curve 70), a damping mode 55 is excited. The damping mode 55 is not present in the comparative example. The damping mode 55 effectively damps the damped membrane displacement 60.

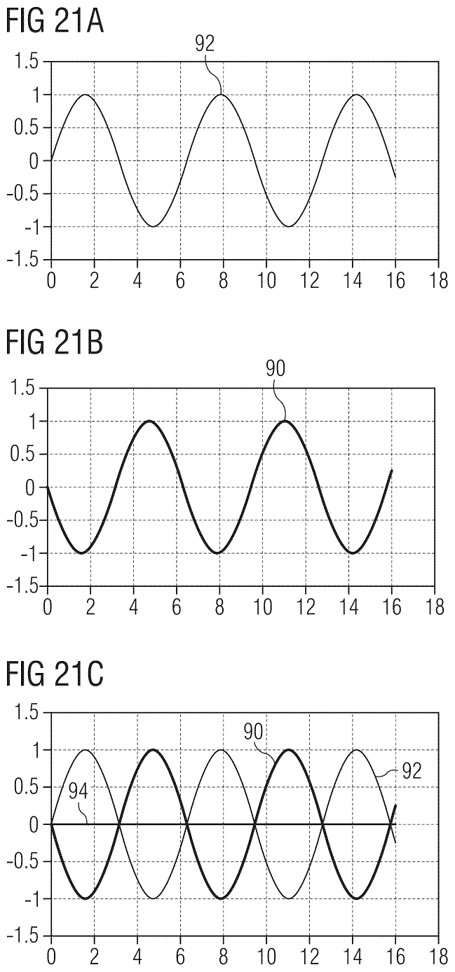

FIG. 17 shows a signal 80 of a damped membrane displacement 60 as voltage 101 specified in mV as a function of time 102 specified in ms. The signal 80 is, for example, detected by the detecting means 23 after damping with the damping means 22. FIG. 17 further illustrates that the signal 80 contains a frequency 81 of the actuating signal 6 and the damping mode 55. For this purpose, the signal 80 was filtered with a narrow-band bandpass filter around the frequency 81 of the actuating signal 6 and the damping mode 55. As can be seen in FIG. 17, both the actuating signal 6 and the damping mode 55 are contained in the signal 80.

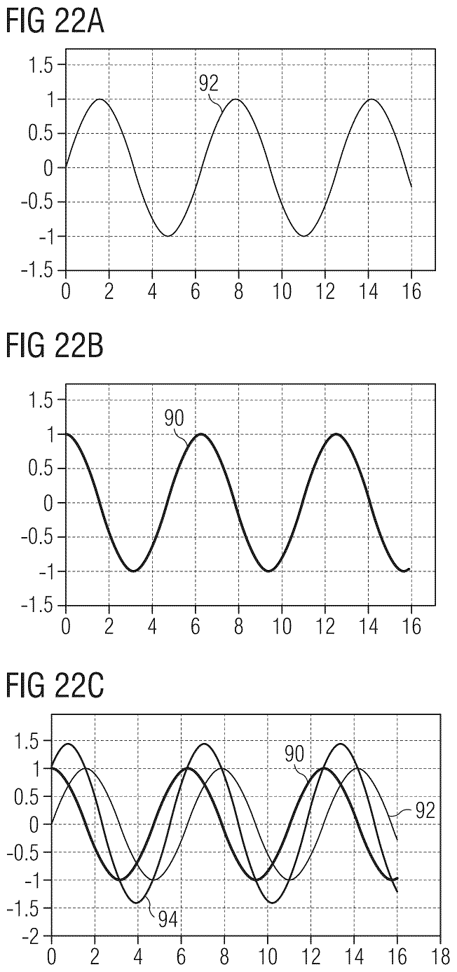

FIG. 18 shows a signal 90 of an ultrasonic signal that was reflected by an object to be measured and is received by the ultrasonic transducer 1. The reflected ultrasonic signal generates a membrane displacement 60, which can be represented as a voltage 101 in mV via the piezoelectric effect. Signal 90 contains one signal each with the frequency 91 of actuating signal 6 and damping mode 55, which can be represented from signal 90 analogously to FIG. 17.

As can be seen in FIG. 18, the damping mode 55 only has a small proportion in the signal 90. Thus, the damping mode 55 has only a negligible influence on the result of a distance measurement. Furthermore, a maximum of an envelope of the signal 90 can be recognized, which can be used to determine the distance of the object. In the present example, the distance of the object from the ultrasonic transducer is 15 cm.

In contrast to FIG. 18, FIG. 19 shows a comparison signal 95 of an ultrasonic signal reflected by the object to be measured, without any damping of the ringing 40 of the membrane 4. As can be seen in FIG. 19, the comparison signal 95 is essentially determined by a frequency 96 of the actuating signal 6, and an envelope of the comparison signal 95 decreases continuously. This means that the distance of the object from the ultrasonic transducer cannot be determined.

Furthermore, a comparison with FIG. 18 shows that the comparison signal 95 has an amplitude that is one order of magnitude higher than that of the signal 90. This means that all information in the comparison signal 95 that could be used to determine the distance of the object is masked by the ringing 4 of the membrane 4, so that the distance of the object cannot be determined.

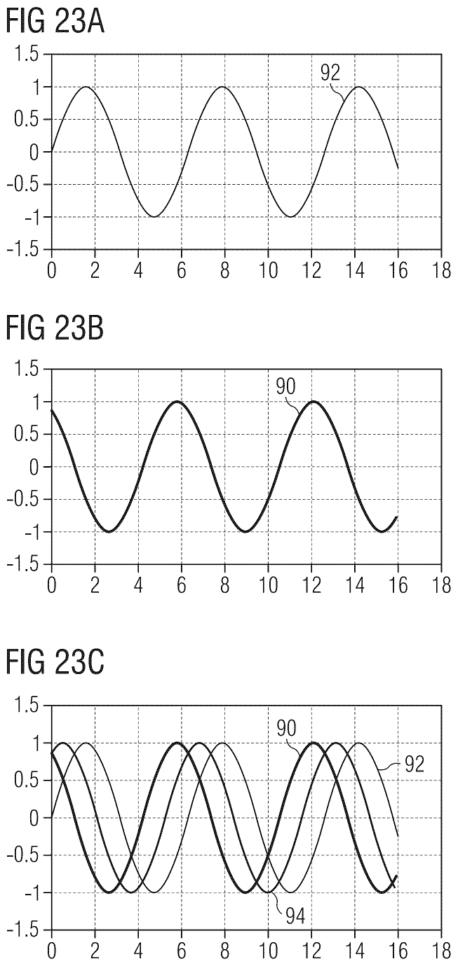

FIG. 20 illustrates a method described herein for operating an ultrasonic transducer according to a second exemplary embodiment. As in the first exemplary embodiment of FIG. 9, the fixed part 5a of the damping signal 5 is determined before the excitation of the membrane 4 with the actuating means 21 and stored in the first register 30a of the memory unit 30. The ambient parameter 32 can be taken into account in this process.

As in the exemplary embodiment of FIG. 9, the distance 105 is determined in a first measurement cycle 200, whereby the first variable part 5b of the first damping signal 5 of the first measurement cycle 200 is additionally stored in a second memory register 30b of the memory unit.

The first measurement cycle 200 is followed by a second measurement cycle 201, in which the membrane 4 is excited with the actuating signal 6 to emit a second ultrasonic wave 7. Subsequently, the second ringing 40 of the membrane 4 is damped by means of the damping means 22 by providing the second fixed part 5aa of the second damping signal 57. The second fixed part 5aa is in particular identical to the first fixed part 5a and is retrieved from the first register 30a.

While the fixed part 5aa is provided, the detecting means detects a second swinging parameter 9. The adapting means 24 determines a second variable part 5bb of the second damping signal 57 from the second swinging parameter 9 and the first variable part 5b of the first damping signal 5.

The second variable part 5bb is then provided to the damping means 22 in order to further dampen the second ringing.

The detecting means 23 subsequently detects a second reflected wave, from which a distance can be determined. The distance 105 is finally obtained as the result from the distance of the first measurement cycle 200 and the distance of the second measurement cycle 201. The measurement cycles 200, 201 can then be repeated.

The method according to the second exemplary embodiment can be carried out in particular if, despite effective damping with the damping means 22, the ringing is not completely suppressed.

In this case, it is possible that a reflected ultrasonic wave superimposes with the ringing. The result of the superimposition depends on the phase relationship between the reflected wave and the ringing that has not completely decayed.

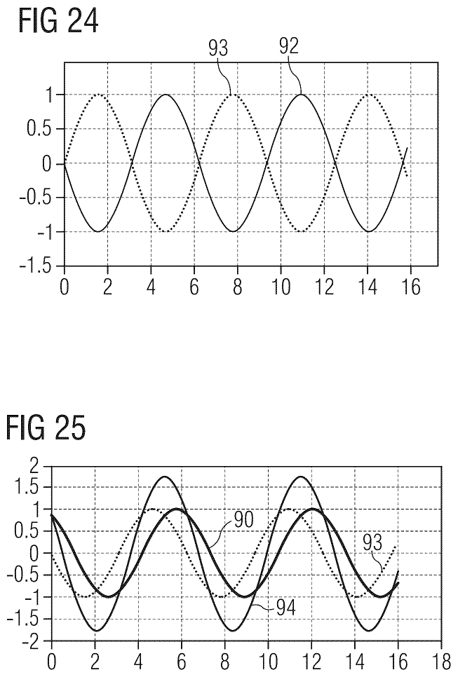

As illustrated in FIGS. 21A to 21BC, superimposition of the reflected wave (illustrated by signal 90) and the not completely decayed ringing (illustrated by signal 92) results in a membrane oscillation amplitude of essentially zero (illustrated by signal 94). The phase shift between the reflected wave and the ringing is π or 180° in this example.

As illustrated in FIGS. 22A to 22C, in another example, superimposition of the reflected wave (illustrated by signal 90) and the not completely decayed ringing (illustrated by signal 92) results in an increased amplitude of the membrane oscillation (illustrated by signal 94). The phase shift between the reflected wave and the ringing in this example is π/2 or 90°.

In another example, superimposition of the reflected wave (illustrated by signal 90) and the not completely decayed ringing (illustrated by signal 92) results in a substantially unchanged amplitude of the membrane oscillation (illustrated by signal 94), as illustrated in FIGS. 23A to 23C. The phase shift between the reflected wave and the ringing in this example is ⅔ π or 120°.

In the example of FIGS. 23A to 23C, it is therefore not possible to measure the distance, since the reflected wave does not cause any change in the amplitude of the membrane oscillation and thus the time of arrival of the reflected wave cannot be determined.

In this case, a second ultrasonic wave 7 can be emitted in the second measurement cycle 201 using the method shown in FIG. 20. Since the measurement cycles 200, 201 follow each other directly and the duration of a measurement cycle 200, 201 is relatively short, it can be assumed in many applications that the distance 105 and thus the reflected wave does not change or changes only insignificantly between the measurement cycles 200, 201.

By the method of FIG. 20 the second ringing is damped in such a way that a second ringing that has not completely decayed (illustrated by signal 93 in FIG. 24) is phase-shifted by π or 180° relative to the first ringing (illustrated by signal 92 in FIG. 24). As a result, the second ringing and the reflected wave have a phase relationship with each other in which the amplitude of the membrane oscillation changes when they are superimposed (illustrated by signal 94 in FIG. 25). This allows a change in amplitude to be determined when the second ringing is superimposed on the reflected wave, and the distance 105 to be determined.

The invention is not limited to the examples described herein. Rather, the invention encompasses any new feature and any combination of features, including in particular any combination of features in the patent claims, even if this feature or combination is not explicitly stated in the patent claims or exemplary embodiments.

1.-23. (canceled)

24. An ultrasonic transducer comprising:
a membrane disposed in a housing;
an actuator; and
a damper,
wherein the actuator is configured to excite the membrane to oscillate in a sending mode for emitting an ultrasonic wave,
wherein the damper is configured to:
dampen a post-excitation ringing of the membrane, and
excite at least one damping mode that is different from the sending mode, and
wherein at least one side wall of the housing has at least one thickness such that the sending mode and the damping mode are stably excited.

25. The ultrasonic transducer according to claim 24,
wherein the side wall of the housing has at least a first region and a second region, and
wherein, in the first region, the side wall has a thickness that is greater than a thickness of the side wall in the second region.

26. The ultrasonic transducer according to claim 24, wherein the sending mode has a maximum in a central region of the membrane.

27. The ultrasonic transducer according to claim 24, wherein the damping mode has a maximum in a peripheral region of the membrane.

28. The ultrasonic transducer according to claim 24, wherein the damping mode has a maximum in a region at the side wall of the housing.

29. The ultrasonic transducer according to claim 24, wherein a ratio of a thickness of the side wall in a region adjacent to the membrane to a membrane thickness is 3.

30. The ultrasonic transducer according to claim 24, wherein the housing comprises at least one damping element arranged in at least one region in which the damping mode has a maximum.

31. The ultrasonic transducer according to claim 30,
wherein the side wall of the housing has at least a first region and a second region,
wherein, in the first region, the side wall has a thickness that is greater than a thickness of the side wall in the second region,
wherein a first damping element adjoins the first region of the side wall and a second damping element adjoins the second region of the side wall, and
wherein the first damping element and the second damping element have different damping coefficients.

32. The ultrasonic transducer according to claim 24, wherein the damper is configured to:
excite the membrane with a damping signal, the damping signal having a fixed part and a variable part,
excite the fixed part after exciting the membrane with the actuator, and
excite the variable part after the fixed part.

33. The ultrasonic transducer according to claim 32, wherein the damper is configured to excite the damping mode by the variable part.

34. The ultrasonic transducer according to claim 32, further comprising:
detector; and
adaptor,
wherein the detector is configured to detect at least one swinging parameter of the ringing during the excitation of the fixed part, and
wherein the adaptor is configured to determine the variable part during excitation of the fixed part based on the detected swinging parameter.

35. The ultrasonic transducer according to claim 34, wherein the adaptor is configured to determine the fixed part prior to excitation of the membrane by the actuator.

36. The ultrasonic transducer according to claim 35, wherein the adaptor is configured to determine the fixed part by a population algorithm, and wherein an amplitude of the ringing is a fitness parameter.

37. The ultrasonic transducer according to claim 34, wherein the damping signal comprises at least one damping pulse and the adaptor is configured to determine a plurality of the following parameters for the fixed part and exactly one of the following parameters for the variable part: a number of damping pulses, a width of at least one damping pulse, a sequence of the at least one damping pulse.

38. The ultrasonic transducer according to claim 34, further comprising:
at least one ambient sensor configured to detect at least one ambient parameter,
wherein the adaptor is configured to determine the fixed part by taking into account the ambient parameter.

39. The ultrasonic transducer according to claim 38, further comprising:
controlling electronics comprising a memory unit,
wherein the adaptor is configured to store the fixed part in the memory unit based on the ambient parameter.

40. The ultrasonic transducer according to claim 34,
wherein the adaptor is configured to store the variable part of a first damping signal in a second memory register of a memory unit,
wherein the detector is configured to detect a second swinging parameter of the ringing during an application of a fixed part of a second damping signal,
wherein the adaptor configured to determine a variable part of the second damping signal following the first damping signal based on a stored variable part of the first damping signal and a detected second swinging parameter,
wherein the damper is further configured to apply the second damping signal to the membrane, and
wherein a ringing of the membrane damped by the first damping signal has a phase shift of 180° relative to a ringing of the membrane damped by the second damping signal.

41. The ultrasonic transducer according to claim 40, wherein the first damping signal and the second damping signal have a common fixed part.

42. A method for operating an ultrasonic transducer comprising a membrane in a housing, the method comprising:
exciting the membrane to emit an ultrasonic wave, wherein a first membrane oscillation comprising a stable sending mode with a sending frequency is excited; and
damping a post-excitation ringing, wherein a second membrane oscillation having a stable damping mode with a damping frequency is excited, wherein the damping frequency and the sending frequency are different.

43. The method according to claim 42, further comprising:
performing damping of the ringing by applying a damping signal, the damping signal comprising a fixed part and a variable part,
wherein the variable part follows the fixed part in time,
wherein the fixed part of the damping signal is determined before the sending mode is excited, and
wherein the variable part is determined based on at least one swinging parameter of the ringing, which is determined during application of the fixed part.

44. The method according to claim 42,
wherein the membrane is excited multiple times to emit the ultrasonic wave and damping is performed between two excitations by a damping signal,
wherein a fixed part of the damping signal is determined before the membrane is excited multiple times, and
wherein a variable part of the damping signal is determined during each damping of the ringing based on at least one swinging parameter of the ringing.

45. The method according to claim 44, further comprising:
storing the variable part in a second memory register of a memory unit while damping a first ringing with a first damping signal; and
detecting a second swinging parameter of a second ringing while a subsequent damping of a second ringing with a second damping signal,
wherein a variable part of the second damping signal is determined based on the detected second swinging parameter and a stored variable part of the first damping signal so that the first ringing is phase-shifted by 180° relative to the second ringing.

46. A method for measuring a distance, the method comprising:
measuring, by using exactly one ultrasonic transducer according to claim 24, an object at the distance between 4 cm and 2 m inclusive.
